(19) United States
(12) Patent Application Publication
(10) Pub. No.: US 2007/0083459 A1
(43) Pub. Date: Apr. 12, 2007

(54) System and method for deferring payments

(75) Inventor: Trace Eubanks, Santa Ynez, CA (US)

Correspondence Address: Trace Eubanks, 3631 Roblar Avenue, Santa Ynez, CA, 93460, US

(73) Assignee: Year2pay, Inc.

(21) Appl. No.: 11/244,717

(22) Filed: Oct. 6, 2005

(51) Int. Cl. G06Q 40/00

(52) U.S. Cl. 705/38

(57) ABSTRACT

A system and method for making deferred payment purchases are disclosed. The system includes a deferred payment system provider (which includes a deferred payment server, pre-registered merchants, pre-approved customers and at least one financial institution. The deferred payment server, the customers and the merchants communicate over a network (e.g., the Internet). The pre-approved customers have pre-approved deferred payment credit limits. The customers can make deferred purchases (e.g., online, from brick and mortar stores, from catalogs, etc.) up to the deferred credit limit from the various pre-registered vendors.

### CROSS REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to a deferred payment system, and more particularly to a system and method for purchasing goods and services through multiple channels (Internet, brick and mortar, catalog, etc.) using a single application form and deferred payment credit line.

Online shopping (e-commerce) has experienced explosive growth over the last several years. Predictions are that e-commerce will continue to grow. For example, a Forrestor report estimates that the average online shopping household will spend $1167 online this year and that the figure will increase to $3,738 by 2004.

Historically, credit cards have been the instrument of choice for large purchases as well as for payment of online purchases. This has placed an exorbitant amount of pressure on consumer credit card limits. Combining brick and mortar purchases with escalating Internet purchases, customers are exceeding their credit card limits at a record high.

Deferred payment programs offered by independent financial institutions provide an alternative to credit cards that has successfully been used by brick and mortar retailers for large ticket products, such as appliances and electronic equipment. However, such programs are inefficient because the many financial institutions that offer deferred payment programs require the consumer to submit a separate credit application for each retail establishment from which an item is purchased. The multiple credit inquiries tarnish the consumer's credit score, thus diminishing the chances of approval. Additionally, such programs have not been offered in the services market.

Despite the growth in online shopping, only 38% of today's online visitors are actually making online purchases. Possible reasons for online shoppers not actually making purchases include: consumer concerns about revealing personal and credit card information on an unknown merchant site, consumer difficulty in navigating around various merchant web sites; and customer unwillingness to apply for credit at each of the vendor web sites for risk of jeopardizing their credit rating.

Thus, a need exists for a deferred payment system which requires a single credit application for various products and services offered through multiple sources (e.g., traditional sources, such as brick and mortar stores, as well as online purchases).

### BRIEF SUMMARY OF THE INVENTION

A system and method for making deferred payment purchases are disclosed. The system includes the provider of the deferred payment system. The deferred payment system provider includes a deferred payment server. The deferred payment system includes multiple pre-registered merchants that provide goods and services to users (customers) of the deferred payment system. The system also includes pre-registered customers with an approved credit line for making purchases at pre-registered merchants. One or more financial institutions allow the customers to make deferred purchases within the approved credit limit.

In accordance with other aspects of the invention, an application or registration process allows the users to apply for a deferred credit line. The application process may be performed online (e.g., over the Internet) or offline, e.g., by mail or telephone. Once the user has completed the application and submitted it to the deferred payment system provider, the application is submitted to a financial institution and/or primary/secondary tiered banking/financial systems and/or category banks for approval. The approval and credit limit or denial is reported to the provider of the deferred payment system by the financial institution. The provider of the deferred payment system forwards the approval and credit limit or the denial to the user.

In accordance with further aspects of the invention, once approved, customers can shop and make deferred purchases at the pre-registered vendors. Purchases may be made online (from a site provided by the deferred payment system provider or from a pre-registered merchant's site) or offline (e.g., phone, catalog, brick and mortar store, etc.). The deferred payment system provider obtains the deferred payment amount from a financial institution and forwards the appropriate payment amount to the merchant.

In accordance with yet further aspects of the invention, the deferred payment system is a tiered system with multiple deferral periods, wherein the customer may be approved for different deferral amounts for each deferral period. Additionally, a customer may only qualify for some of the deferral periods.

In accordance with still further aspects of the invention, the customer makes payments to the deferred pavement system provider. The deferred payment system provider makes payments to the financial institution.

### BRIEF DESCRIPTION OF THE DRAWINGS

These as well as other features of the present invention will become more apparent upon reference to the drawings wherein:

FIG. 1 is a block diagram of a deferred payment system formed in accordance with the present invention;

FIG. 2A is an exemplary home page for a deferred payment system provider;

FIGS. 2B and 2C are lists of exemplary products and services which may be purchased using a deferred payment system formed in accordance with the present invention;

FIGS. 3A-3D illustrate exemplary deferred payment option cards;

FIG. 4 is a flow diagram illustrating exemplary logic for performing a registration process in accordance with the present invention;

FIG. 5 is a flow diagram illustrating exemplary logic for performing a login process in accordance with the present invention;

FIG. 6 is a flow diagram illustrating exemplary logic for shopping using a deferred payment system in accordance with the present invention;

FIG. 7 is a flow diagram illustrating exemplary logic for selecting products to purchase during the shopping logic of FIG. 5;

FIGS. 8A and 8B are a flow diagram illustrating exemplary logic for performing a checkout procedure during the shopping logic of FIG. 6; and

FIG. 9 is a flow diagram illustrating exemplary logic for making purchases in the checkout procedure of FIGS. 8A and 8B;

FIG. 10 is a flow diagram illustrating exemplary logic for processing a payment in accordance with the present invention; and

FIGS. 11 and 12 illustrate exemplary deferred payment system logos.

### DETAILED DESCRIPTION OF THE INVENTION

The present invention discloses a system and method that allows a user to purchase various goods and services using a delayed or deferred payment system. The system allows the user to make purchases using a variety of mechanisms (e.g., the Internet, catalogs, television, traditional brick and mortar stores, or directly from the manufacturer). The present invention removes the credit application responsibilities from the merchant and introduces a pre-approved customer to the merchant's front door or website.

As described in further detail below, a customer completes an application. If approved, the customer is provided with a credit limit. The customer can then make purchases at any merchant that accepts payments using the deferred payment system. The customer can continue to make purchases until his or her credit limit has been reached.

As with traditional deferred payment systems, the customer does not have to make any payment for a specified deferral period (e.g., one year). Preferably, even though a payment is not due for a deferred time period, statements will be provided on a regular basis, for example monthly. Preferably, the customer can pay a portion or the entire balance at any time prior to expiration of the deferral period without incurring any interest or pre-payment penalties. Preferably, the customer can make payments after the expiration of the deferral period. However, if the customer wishes to make payments rather than pay the entire balance upon the expiration of the deferral period, the customer will be subject to interest payments. For example, after a one year deferral period, minimum monthly payments, including interest, similar to credit card payments may be made.

As described above, the deferred payment system of the present invention allows a customer to make purchases from a variety of merchants, including merchants who sell over the Internet. Preferably, a site will be provided by the provider of the deferred payment service which will allow a customer to purchase goods and services using the deferred payment system. For example, the site may have a hierarchical list which allows the user to shop for desired goods and services. Additionally, a customer can use the deferred payment system for purchases made at a vendor's site. For example, vendors participating in the system may include a “deferred payment” logo on their site, for example on their home page and/or on their checkout page.

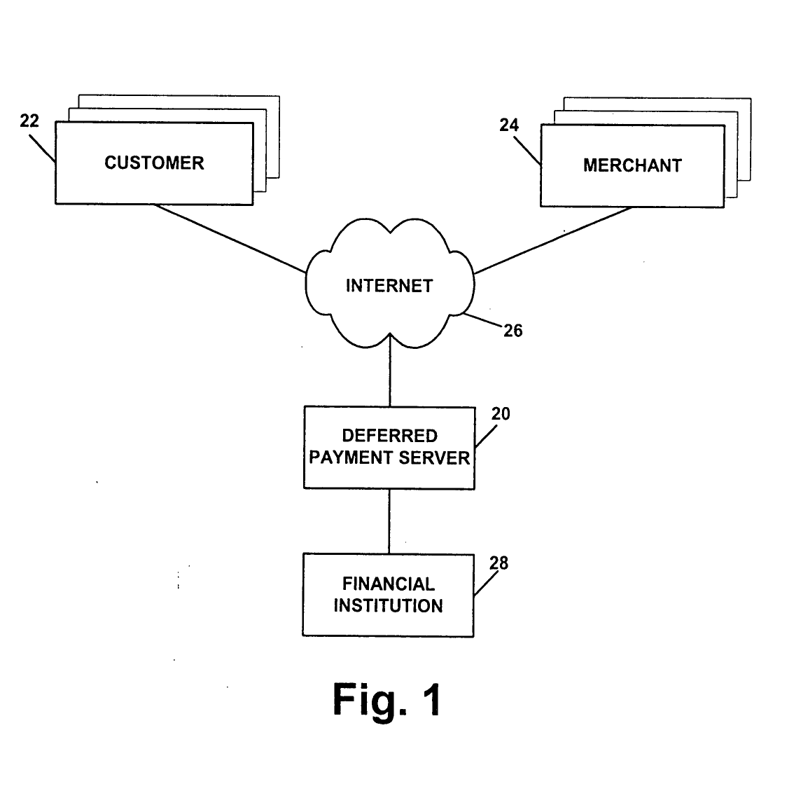

FIG. 1 is a block diagram illustrating exemplary components of a deferred payment system formed in accordance with the present invention. The system includes a deferred payment server 20 operated by a deferred payment server provider. The deferred payment server 20 includes a data repository for storing information about participating merchants 24 and customers 22. Potential customers 22 can apply for a deferred credit line. Applications can be requested and submitted in various ways, for example, via phone, at a store location, via mail, facsimile or over the Internet. Online application submission over the Internet is described below. The online application process is accomplished by an applicant communicating with the deferred payment server 20 over a network 26, such as the Internet. Once approved, the customer 22 can make purchases over the Internet 26 using a site provided by the deferred payment server 20. Additionally, customers 22 can make online purchases from participating merchants 24 via web sites provided by the merchants. Purchases can also be made offline, for example from brick and mortar stores, over the telephone or by mail order.

The deferred payment server 20 communicates with one or more financial institutions 28 during the application process in order to determine if a customer 22 is approved for deferred payments. If a customer 22 is approved, the financial institution 28 provides the deferred payment server 20 with a credit limit for the customer 22. The deferred payment server 20 forwards the credit information (approval and credit limit or denial) to the customer 22. In exemplary embodiments, the application is submitted to a primary lender. In various embodiments of the invention, a tiered system is used. If the primary lender denies the customer's credit application, the application is sent to a secondary lender. If the application is denied by the secondary lending institution, the application may be sent to a category bank or financial institution which provides credit or inducements for one or more particular products or product categories, or specific brands of products. If the application is denied by the secondary lender, the customer is notified of the denial.

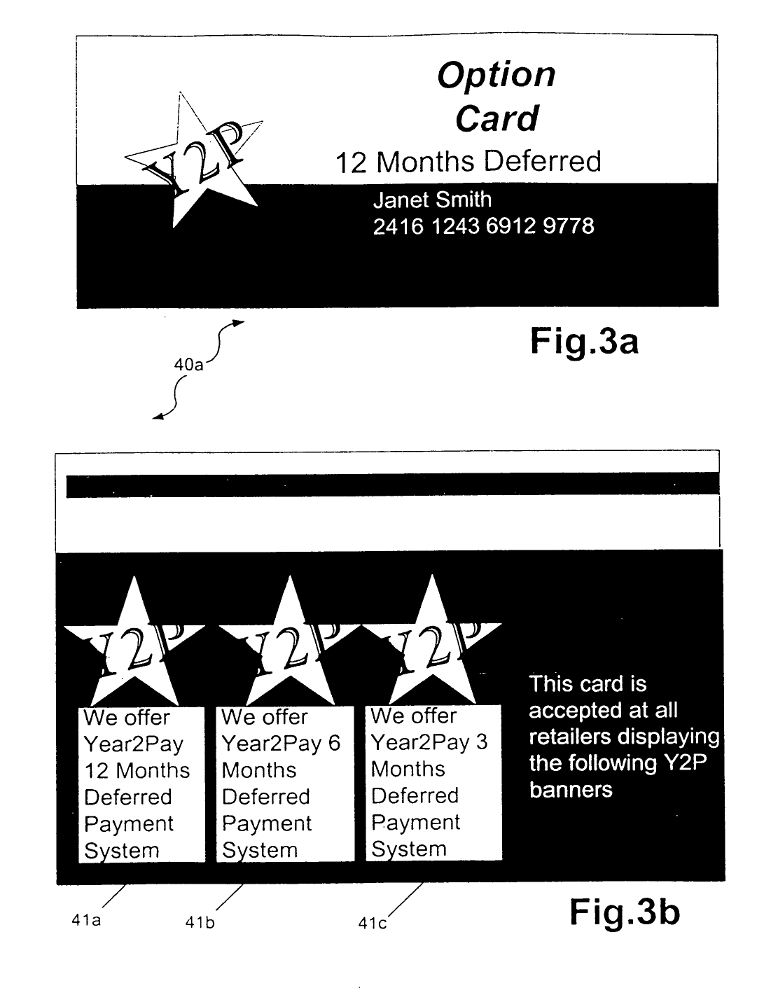

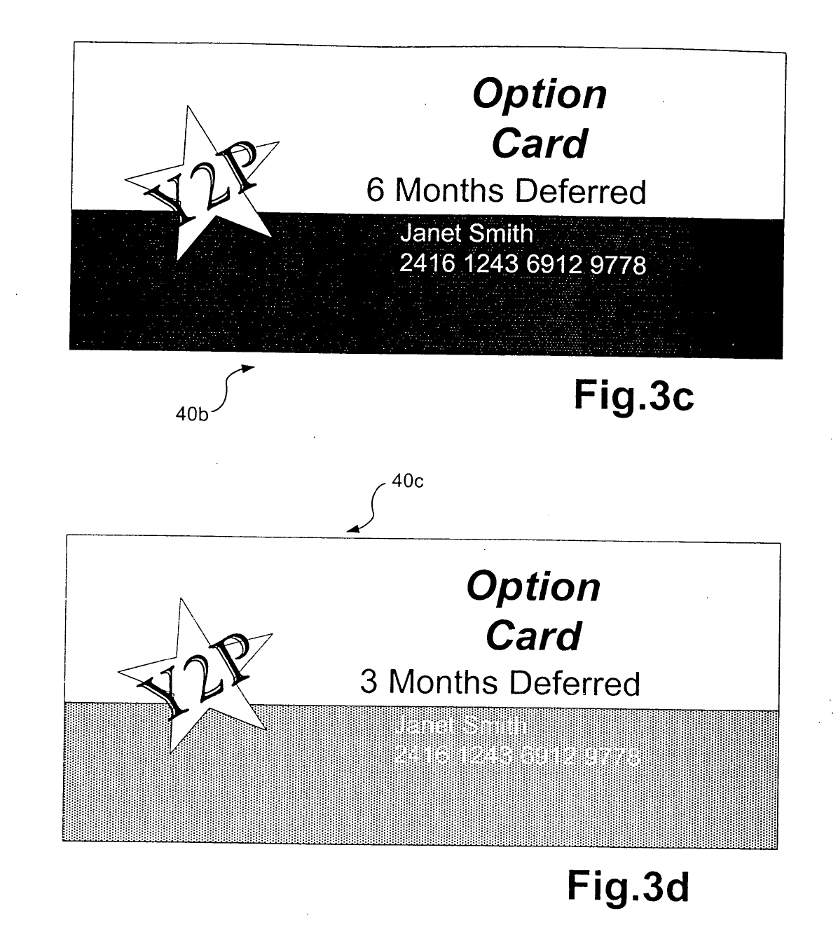

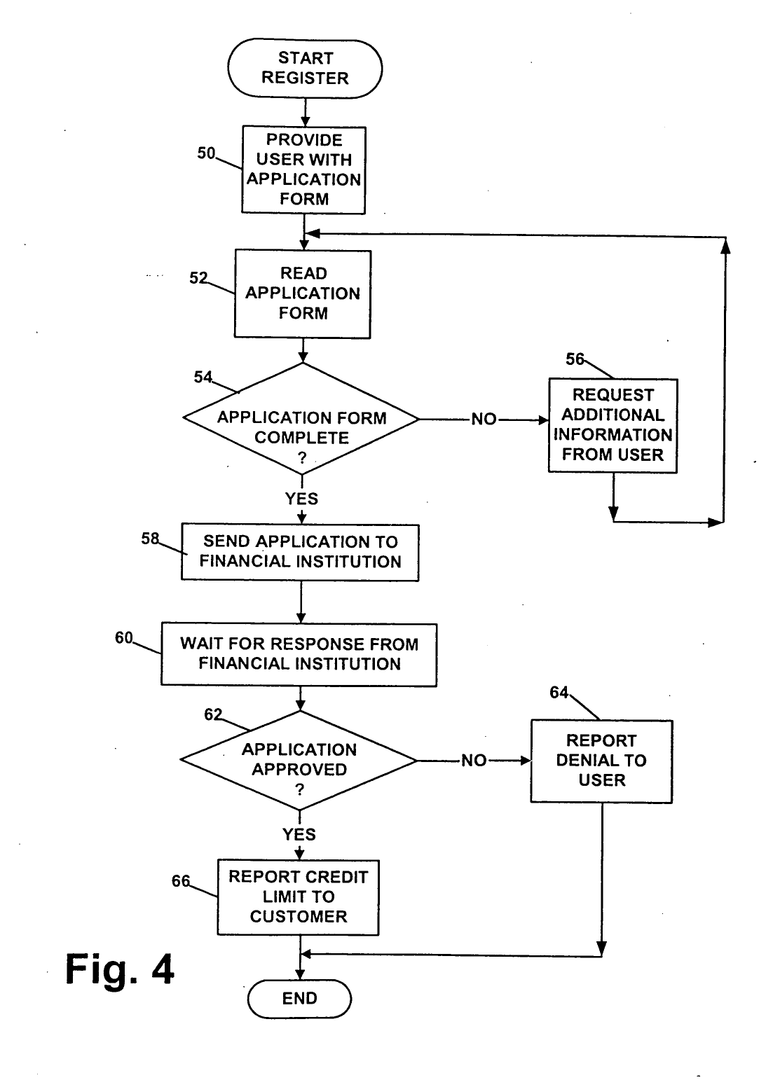

In exemplary embodiments, the deferred payment system is a tiered payment system. For example, based on an applicant's credit score, the applicant may be approved for a credit limit of $1,000 for purchases deferred for twelve months, a credit limit of $2,500 for purchases deferred for six months and a credit limit of $5,000 for purchases deferred for three months. In exemplary embodiments, a card is issued to approved customers. Preferably, one credit card is issued for all approved options. For example, option card 40a, shown in FIGS. 3A and 3B, is issued to a customer approved for all three credit levels. The front of the option card 40a, shown in FIG. 3A indicates the longest deferral period, for example twelve months. The back of the card 40a, shown in FIG. 3B, indicates all approved tiers, for example, twelve months, six months, and three months. An applicant may not be approved at all levels. For example, as shown in FIG. 3C, an applicant may be approved for six months, but not for twelve months. The back of card 40b (not shown) will be similar to the back of card 40a, shown in FIG. 3B, except that there will be no indication of the twelve month deferral payment system. Similarly, card 40c shown in FIG. 3D can be used for purchases deferred for three months, but not for six months or twelve months. The back of credit card 40c will be similar to that of 40a shown in FIG. 3B, except that only the indication of the three month deferred payment system will be shown. There will be no indication for the twelve month system or the six month deferral system. Preferably, information, such as the credit limit for each available deferral period, is stored on the card, along with information regarding how much credit is still available. The card may be a magnetic stripe card, such as the one shown in FIG. 3B or some other format, such as a smart card.

When a customer 22 makes a purchase, the provider of the deferred payment server obtains the appropriate payment amount from the financial institution 28 and pays the merchant 24 for the goods or services purchased by the customer 22. In exemplary embodiments, a minimum purchase amount is required for deferred purchases. For example, a minimum purchase of $500 may be required. In various embodiments, a minimum purchase amount may be achieved by accumulation of more than one product purchased using the deferred payment system. Additionally, the purchase must be less than the customer's available credit limit. The customer 22 makes payments to the provider of the deferred payment server and the deferred payment server provider then makes the appropriate payments to the financial institution 28.

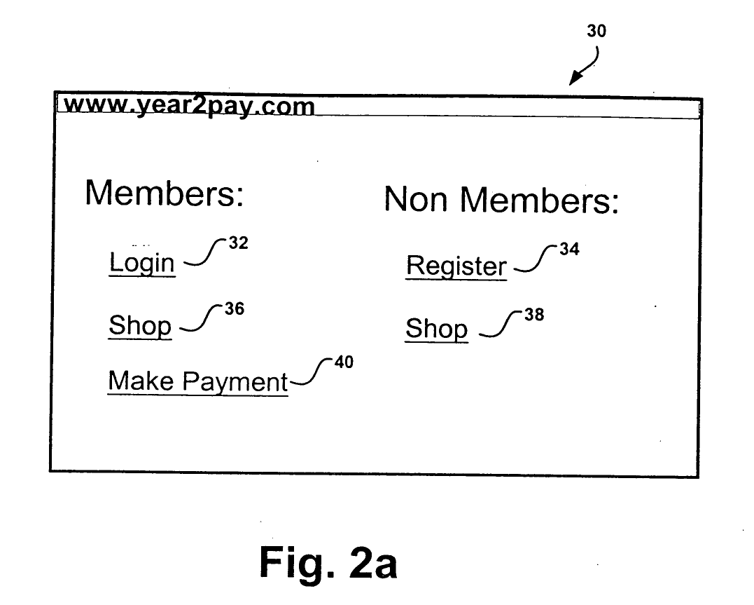

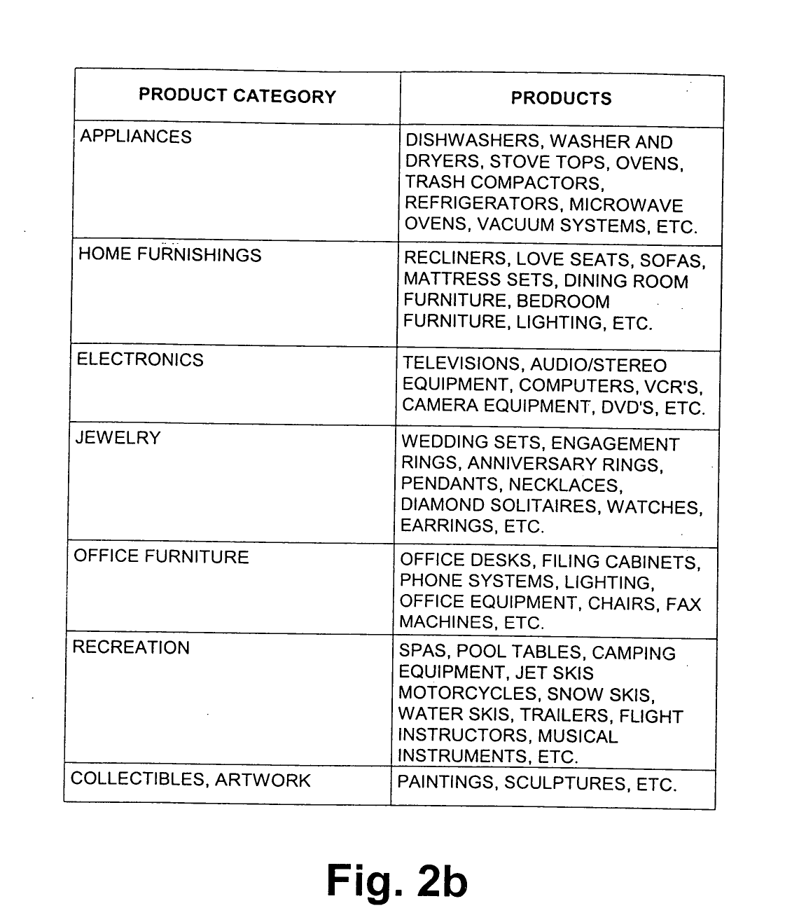

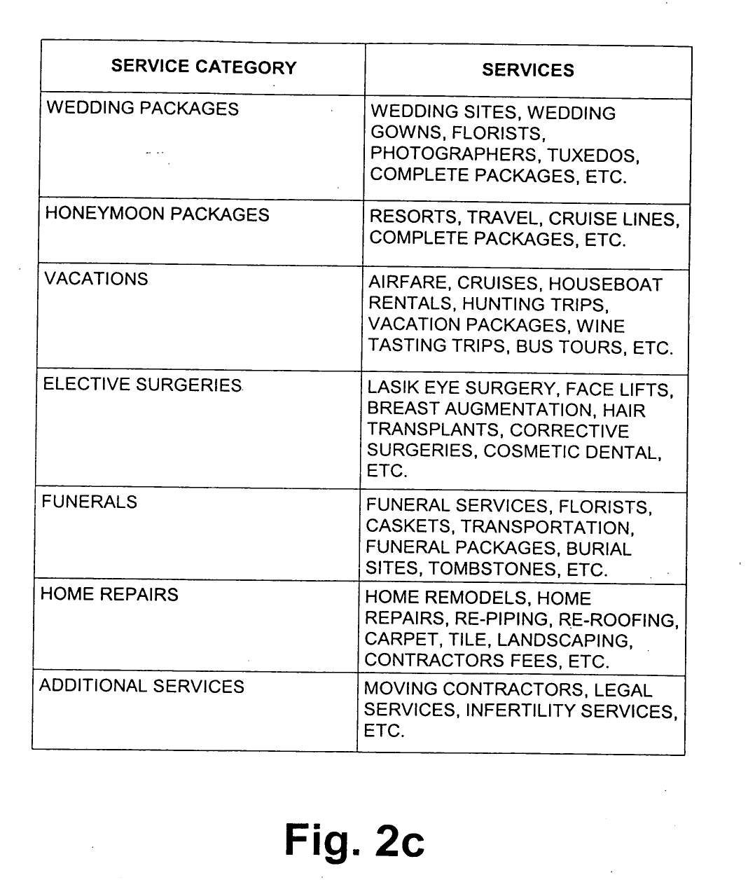

As mentioned above, in exemplary embodiments customers can apply for deferred payments and make deferred purchases online. FIG. 2A is an exemplary screen display showing functionality that can be performed online. In exemplary embodiments (not shown), the display also includes advertisements, for example, banner ads for products and/or services offered by merchants that accept deferred payments. The advertisements can be blanket advertisements (i.e., the advertisement is displayed regardless of the user viewing the page) or targeted based on known information (e.g., answer to questions during the application process) and/or previous behavior (purchases) of the user. Even the “blanket” advertisements of the present invention are targeted in that they are only being received by pre-approved users or users who are likely to apply for the deferred payment system. In exemplary embodiments, merchants “subscribe” to the preferred payment service. Merchant subscription fees may be based (at least in part) on the desired advertising (e.g., blanket banner ads, targeted banner ads, advertising circulars included in statements, etc.).

In the illustrated example, a customer can go to a deferred payment system provider site. The exemplary home page of the deferred payment system provider site 30 allows an existing customer or member to login 32 and to shop (i.e., make purchases) 36. Exemplary embodiments may also allow a customer 22 to make online payments 40. For example, a customer 22 may be able to pay all or a portion of the deferred payment balance via credit line or electronic funds transfer. Alternative embodiments accept only traditional offline means of payment, for example cash, check, money order, etc. Still other embodiments accept both online and offline forms of payment. Non-members can register 34 or shop 38, but cannot make purchases (e.g., can browse for available goods and services). FIGS. 4-10 are flow diagrams illustrating exemplary logic for performing the available functions shown in FIG. 2A.

If the customer is not a member, the customer may register 34 (i.e., apply for the deferred credit line). FIG. 4 is a flow diagram illustrating exemplary logic for a registration or application process performed in accordance with the present invention. Preferably, the registration process is a secure process, for example using a secure protocol, such as Secure Hypertext Transfer Protocol (HTTPS). The logic moves from a start block to block 50 where a suitable user interface is displayed. For example, the user may be asked to enter name, address, social security number, telephone number and employment information. Preferably, the user can also register offline, for example, by printing out a blank application form, filling it out and either submitting it via mail or via facsimile. Alternatively, a user may be able to apply by speaking with a customer service representative over the telephone. Once the appropriate information is obtained from the user, the application is read (block 52) and verified for completeness. If the application is not complete (no in decision block 54), the logic moves to block 56 where the user is asked for the missing information. The process is repeated until the application is complete (yes in decision block 54).

Once the application is complete, the information is submitted to one or more financial institutions for approval. See block 58. The financial institution determines whether the prospective customer is approved or denied and establishes a credit limit for approved customers. In exemplary embodiments, credit limits are established for each available deferral period (e.g., three months, six months and twelve months). After submitting the application, the logic moves to block 60 to wait for a response from the financial institution. It will be appreciated that other logic is being performed during this time. It will be appreciated that various mechanisms can be used for the communication between the provider of the deferred payment system and the financial institution. Preferably, the financial institution has an online service that can provide an immediate response, for example, a customer can be approved within thirty seconds of submitting an application. Once the deferred payment system provider receives the results, they are reported to the user. If the application is not approved (no in decision block 62), the logic moves to block 64 where the denial is reported to the user. The method of reporting the denial to the user depends on the method that the user used to apply. For example, if the application is submitted over the Internet, the denial may be reported via e-mail and regular mail. The denial may also be reported via fax. via regular mail only or via telephone, as appropriate. If the application is approved (yes in decision block 62), the logic moves to block 66 where the approval is reported to the new customer along with an appropriate credit limit(s) and a customer code to be used when making deferred payment purchases. In exemplary embodiments, a card 40a (shown in FIGS. 3A and 3B) is mailed to the approved customer, along with a letter indicating credit limit(s) for each approved deferral period and other pertinent (e.g., legal) information. As with reporting a denial, the method of reporting approval of an application is dependent on the method used for submitting the application. Once approved, the customer can immediately shop and make deferred purchases. It will be appreciated that in exemplary embodiments, an existing customer can also apply for an increased limit using a similar application process.

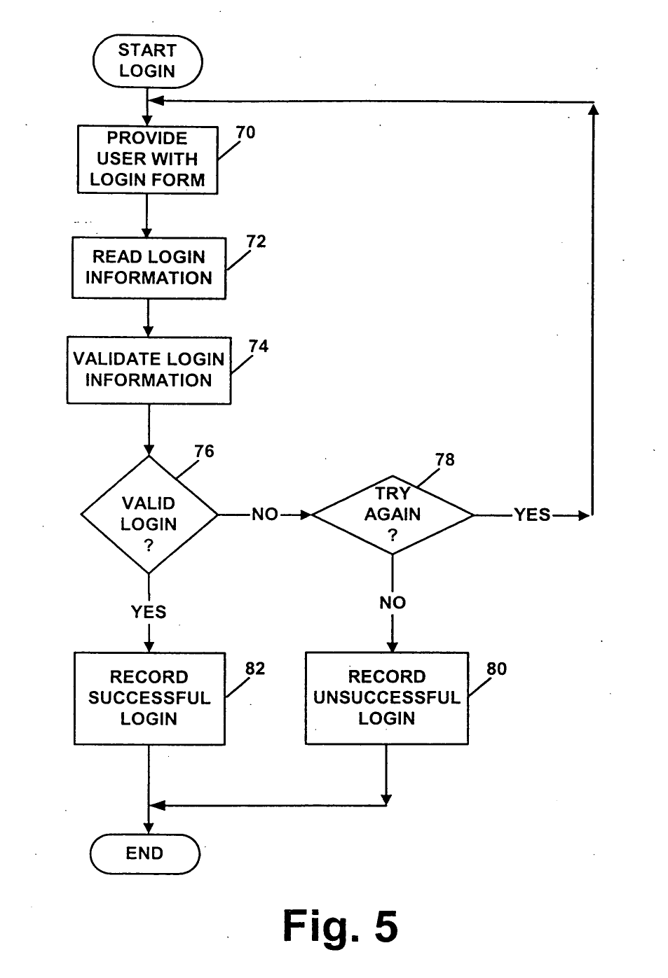

If a registered customer opts to log in 32, a login procedure such as the exemplary login procedure shown in FIG. 5 is performed. Preferably, the login procedure is a secure process, for example using a secure protocol such as. HTTPS. The logic of FIG. 5 moves from a start block to block 70, where a suitable login screen is displayed. For example, the user may enter a user identification (for example, name and/or deferred payment system identification number) and a password. After the user enters the requested information and so indicates (for example by pressing a “Submit” button), the entered information is read (block 72) and validated (block 74). If the login is not valid (no in decision block 76), the user may be provided with an opportunity to try to login again if desired. If another login attempt is desired (yes in decision block 78), the logic returns to block 70. The logic of blocks 70-76 is repeated until a successful login occurs (yes in decision block 76) or the login process is aborted (no in decision block 78). The success (block 82) or failure (block 80) of the login process is recorded and the logic of FIG. 5 ends.

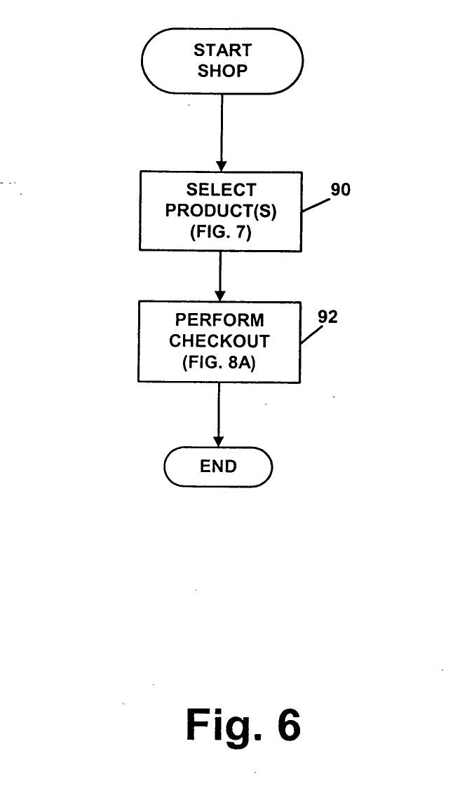

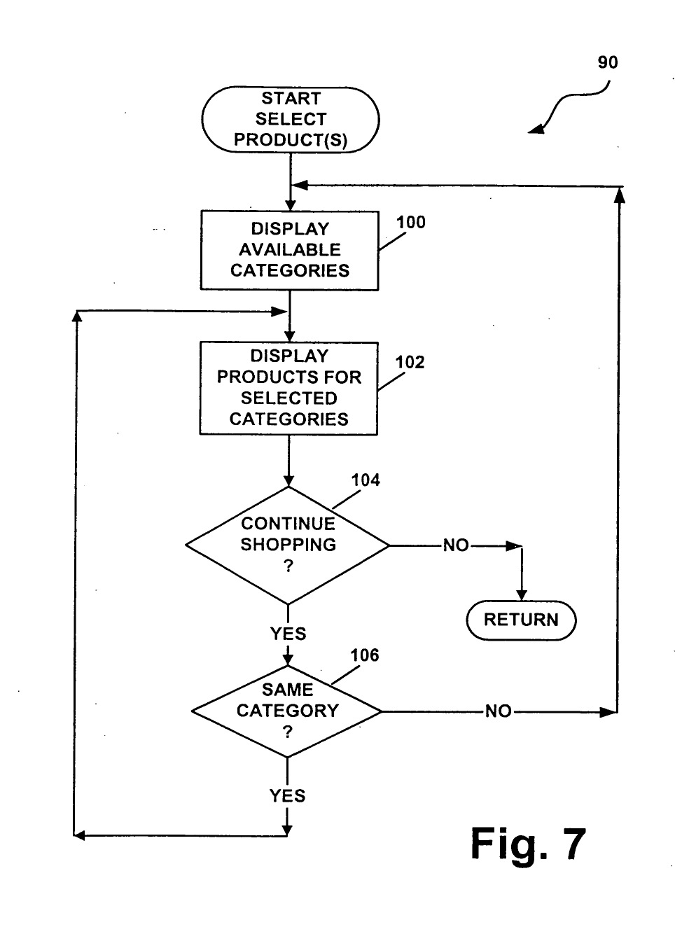

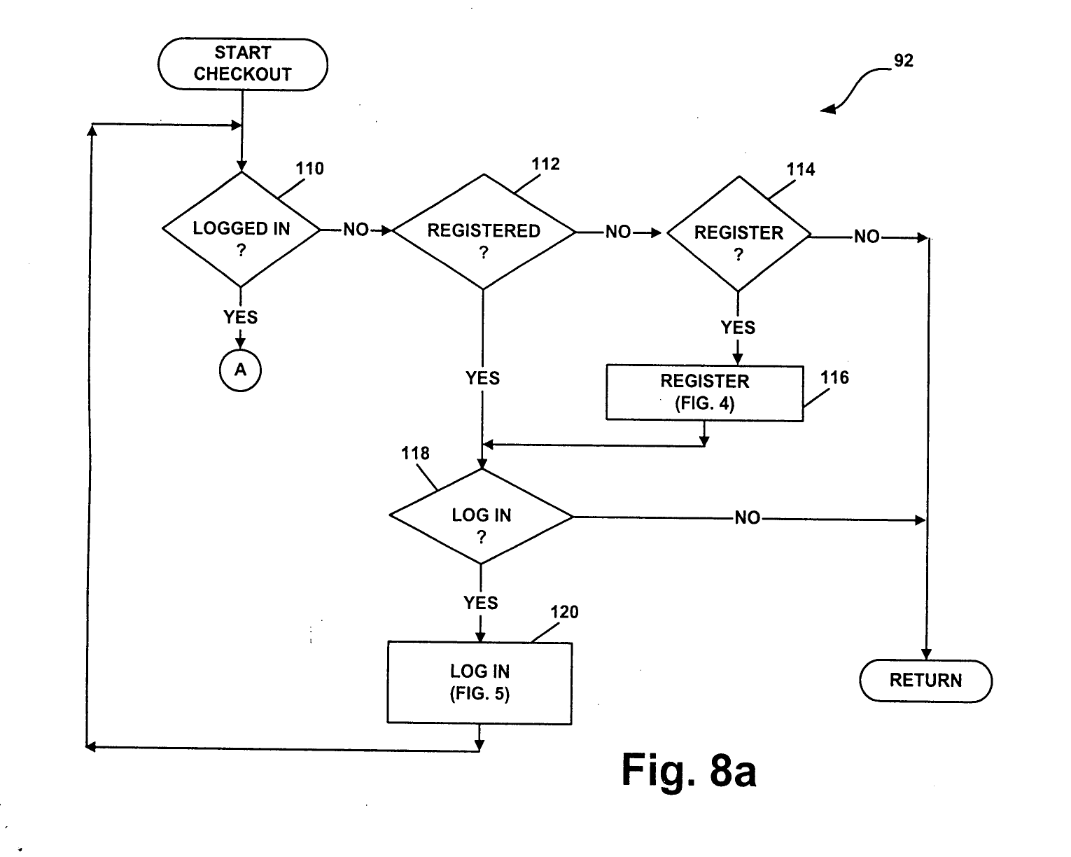

As shown in FIG. 2A, preferably users can shop (e.g., browse without making a purchase) regardless of whether they are logged in or even registered. However, when it is time to make an online purchase, the user must be a registered user and must be logged in. Exemplary logic for shopping online is shown in FIG. 6. The logic of FIG. 6 moves from a start block to block 90 where the user selects one or more goods or services as shown in further detail in FIG. 7 and described next.

As described above, FIG. 2A is a simplistic example of a main display (home page) of a site provided by the deferred payment system provider. Among the options provided is the option to shop. In exemplary embodiments, any product or service available using the deferred payment system can be accessed through this site. The access may be provided directly by the deferred payment system provider's site and/or by using links to merchant sites. In the exemplary screen shown in FIG. 2A, a “Shop” button 36, 38 or link is displayed on the home page. Upon selecting the shop option from the deferred payment system provider site, the logic of FIG. 7 moves from a start block to block 100 where a list of categories is provided to the user. It will be appreciated that in various embodiments the list of categories may be provided on the home page. Once a category is selected, a list of available products for the selected category is displayed. See block 102. FIG. 2B is an exemplary list of product categories and products. FIG. 2C is an exemplary list of service categories and services. After selecting a product or service, the user can continue to shop by selecting additional products or services in the same category and/or different categories. If the user wishes to continue shopping (yes in decision block 104), a determination is made as to whether the user wishes to shop in the same category (yes in decision block 106) or a different category (no in decision block 106). If the user wishes to shop in the same category (yes in decision block 106), the logic returns to block 102 where the list of available products for the category is redisplayed (if the user had changed to another display, for example to see detailed information for a specific product) or continues to be displayed. If the user wishes to shop in a different category (no in decision block 106), the logic returns to block 100 to display the available categories. It will be appreciated that the available categories may always be displayed on the screen. When the user is done shopping (no in decision block 104) the logic of FIG. 7 ends and processing returns to FIG. 6.

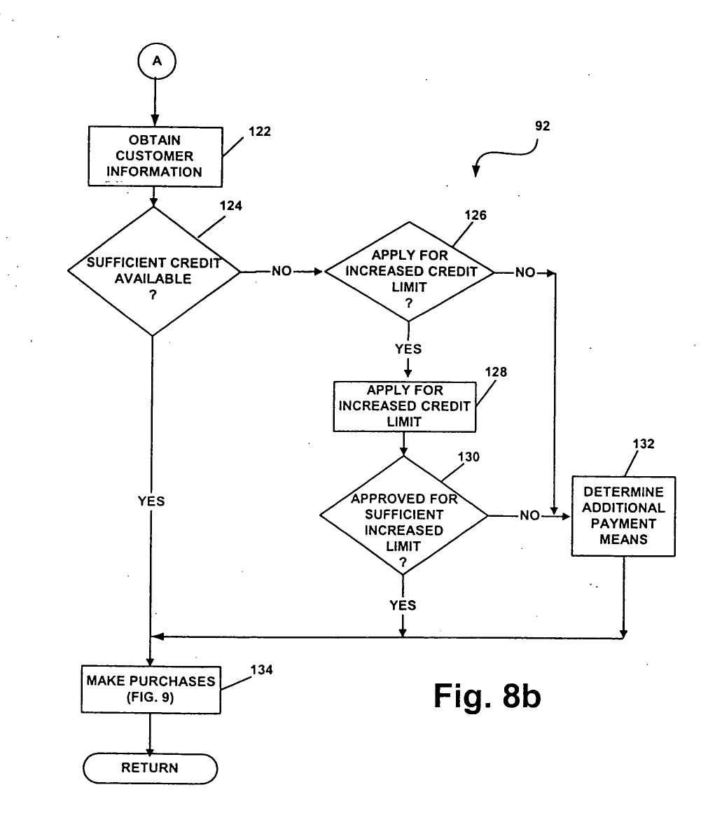

Returning to FIG. 6, after the user has selected the desired product(s), the logic moves to block 92 where a checkout procedure is performed, if desired. The checkout procedure is invoked when the customer indicates that he or she wishes to purchases selected product(s), for example, by pressing a “checkout” button. FIGS. 8A and 8B are a flow diagram illustrating exemplary logic for performing an online checkout procedure in accordance with the present invention. The logic of FIG. 8A moves from a start block to decision block 1 10 where a test is made to determine if the customer is logged in. If the customer is not logged in, the logic moves to decision block 112 where a test is made to determine if the user is registered. For example, if the user is not logged in, a message will be displayed indicating that the user is not logged in. The user will then be able to login if he or she is a registered user. If the user is not registered, he or she will be able to register (i.e., fill out and submit an application). If the user wishes to register (yes in decision block 114), the logic moves to block 116 where a registration or application process is performed. Exemplary logic for performing a registration process is shown in FIG. 4 and described above. If the user is registered, but not logged in, the user may log in. If the user opts to log in (yes in decision block 118), the logic moves to block 120 where a login procedure is performed. Exemplary logic for performing a login procedure is shown in FIG. 5 and described above. In order to make online deferred purchases, the user must be registered and logged in. If the user is not registered or is not logged in and does not wish to log in, the purchases are not made, and the logic of FIG. 8A ends and processing returns to FIG. 6.

If the customer is registered and is logged in (yes in decision block 110), the logic proceeds to block 122 of FIG. 8B where customer information is obtained. For example, the customer is asked to enter his or her name and deferred payment system identification number. Next, the logic moves to decision block 124 where a test is made to determine if the customer has a sufficient credit limit to make the deferred purchases. The available credit limit is determined by subtracting existing purchases made using the deferred payment system for which payments have not yet been made from the customer's credit limit. The price of the selected products which the user wishes to purchase using the deferred payment plan are then compared to the available credit limit.

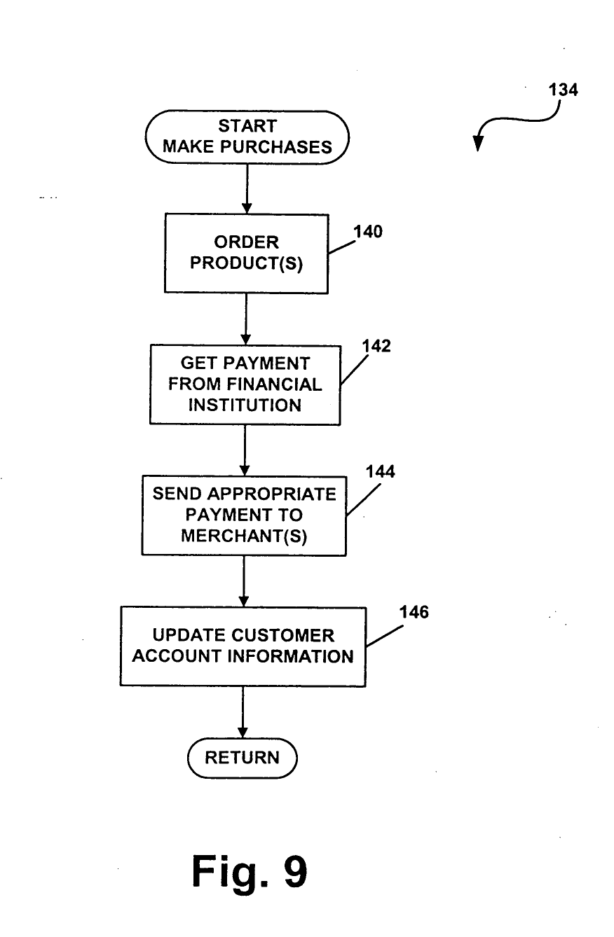

If the customer does not have sufficient deferred credit available (no in decision block 124), the user may be able to apply for a higher credit limit in various embodiments of the invention. If the user wishes to apply for a higher credit limit, an application process is performed. The application process for applying for an increased credit limit is similar to the initial application process shown in FIG. 4 and described above. If the user applies for an increased credit limit, the logic proceeds to decision block 130 where a test is made to determine if the user was approved for the increased limit sufficient to make the desired purchases with the deferred payment system. If not, the logic moves to block 132 where additional means of payment are determined. For example, the user may be able to pay a portion of the payment by credit card and pay for the remainder using the deferred payment option. Once the determination of the method or methods of payment have been made (e.g., already has sufficient credit (yes in decision block 124), has obtained a sufficient deferred credit limit (yes in decision block 130) or finds additional payment means (block 132) ), the logic moves to block 134 where the purchase process is completed. Exemplary logic for making purchases is shown in FIG. 9 and described next.

The logic of FIG. 9 moves from a start block to block 140 where selected products are ordered. The ordering process is similar to existing systems. The user is asked to enter purchase information, such as billing address and shipping address. After the appropriate information has been entered, the products are ordered (e.g., the merchant(s) are notified of the order). Next, the logic moves to block 142 where the payment is obtained from the financial institution. Next, the logic moves to block 144 where the deferred payment system provider sends an appropriate payment to the merchant(s). In exemplary embodiments, a discount fee, e.g., a percentage of the sales price, is paid. This discount fee is similar to the discount fee taken for credit card purchases. For example, the discount fee may be 8% for purchases deferred twelve months, 6% for purchases deferred for six months and 4% for purchases deferred for three months. Therefore, if a customer makes a deferred purchase in the amount of $2,000, using the above discount fees, the customer will always pay $2,000, but the amount kept by the merchant will vary. Under the twelve month deferral option, the merchant will get $1840 and the deferred payment server provider gets $160, under the six month deferral option, the merchant gets $1880 and the deferred payment server provider gets $120 and under the three month option, the merchant gets $1920 and the deferred payment server provider gets $80. Next, the logic moves to block 146 where customer account information is updated. The balance due and date due are updated. The updated information will be reflected on the customer's next statement. The available credit limit is updated to reflect the new available credit limit (e.g., amount of new purchases is subtracted from available credit limit). The logic of FIG. 9 then ends and processing returns to FIG. 8B.

Returning to FIG. 8B, once purchases are made (block 134), the logic of FIG. 8B ends and processing returns to FIG. 6.

Returning to FIG. 6, after the checkout procedure is performed, the logic of FIG. 6 ends. FIG. 6 is a flow diagram illustrating exemplary logic for shopping online via a website provided by the provider of the deferred payment system. As previously mentioned, the deferred payment system can be used for purchases made using sites of participating merchants, by mail, by telephone, etc. It will be appreciated that similar logic is used for purchases made using other methods with slight variations. For example, the method of selecting the product is performed differently. For example, if the purchase is made via telephone, the customer tells a customer service representative what product or products are desired. The customer also verbally provides the personal information, such as name, deferred payment system identification number, etc. If the purchase is made from a merchant site, the user selects the product(s) and/or service(s) and indicates that the purchase is to be made using the deferred payment system. An appropriate page of the deferred payment system provider's site will be displayed, e.g., requesting the user's deferred payment system identification number, etc. Upon completion of the checkout process, the user is returned to the merchant site. Regardless of the purchase method, the customer must be registered, and can only make purchases less than or equal to the available deferred credit limit.

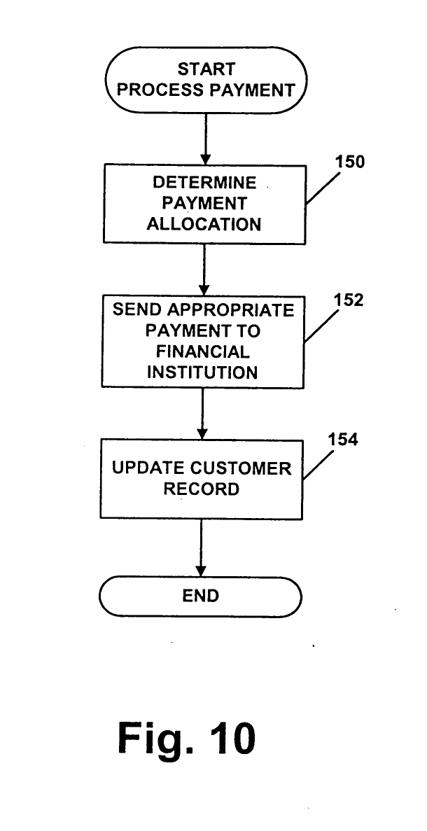

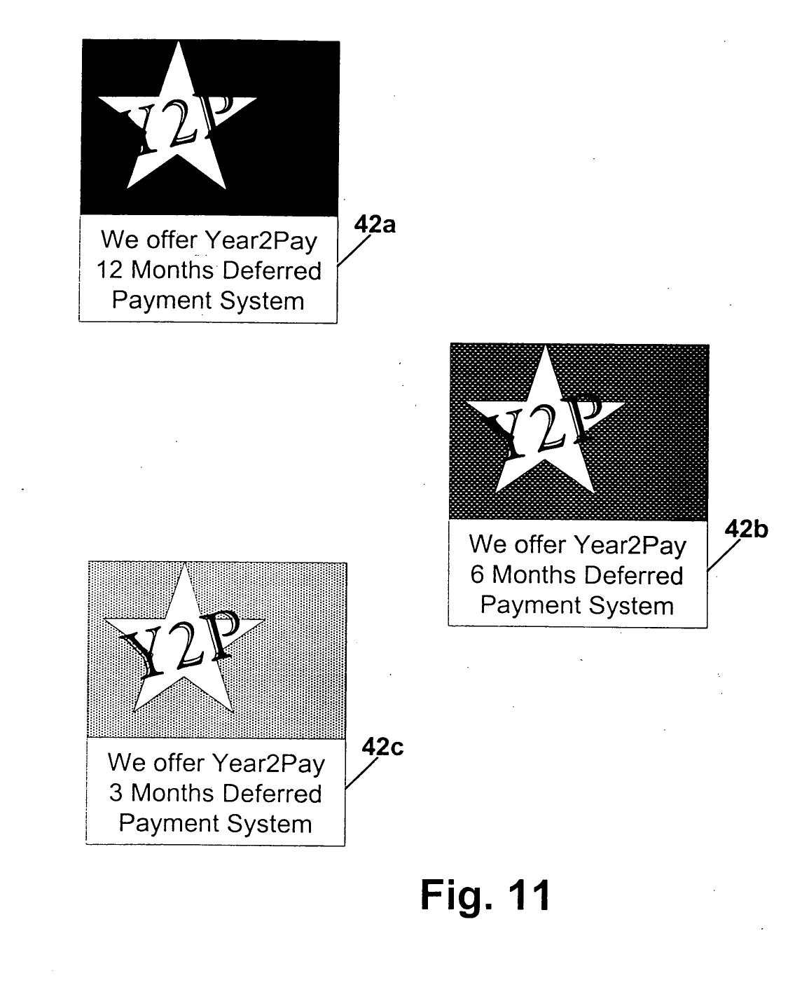

FIG. 10 is a flow diagram illustrating exemplary logic for processing a payment. As described above, a customer is not required to make payments on purchases for a deferred period of time, for example, one year from date of purchase. However, in exemplary embodiments, the customer is provided with periodic (e.g., monthly) statements and can make payments prior to the expiration of the deferral period. Preferably, the statement is a consolidated statement which includes all deferred payment purchases for which the balance has not been paid in full. In exemplary embodiments, no interest is due during the deferral period. If the customer does not pay the remaining balance upon the expiration of the deferral period, the user can make minimum payments. However, payments made after the expiration of the deferral period will be subject to interest charges and late fees, similar to credit card payments. In exemplary embodiments, a portion of the interest goes to the deferred service plan provider and a portion goes to the financial institution. When the provider of the deferred payment system receives a payment from a customer, a determination is made as to the amount due to the financial institution. The appropriate payment is sent to the financial institution. See block 152. The customer record is then updated in block 154. The payment is applied which reduces the balance and increases the available credit limit. The logic of FIG. 10 then ends.

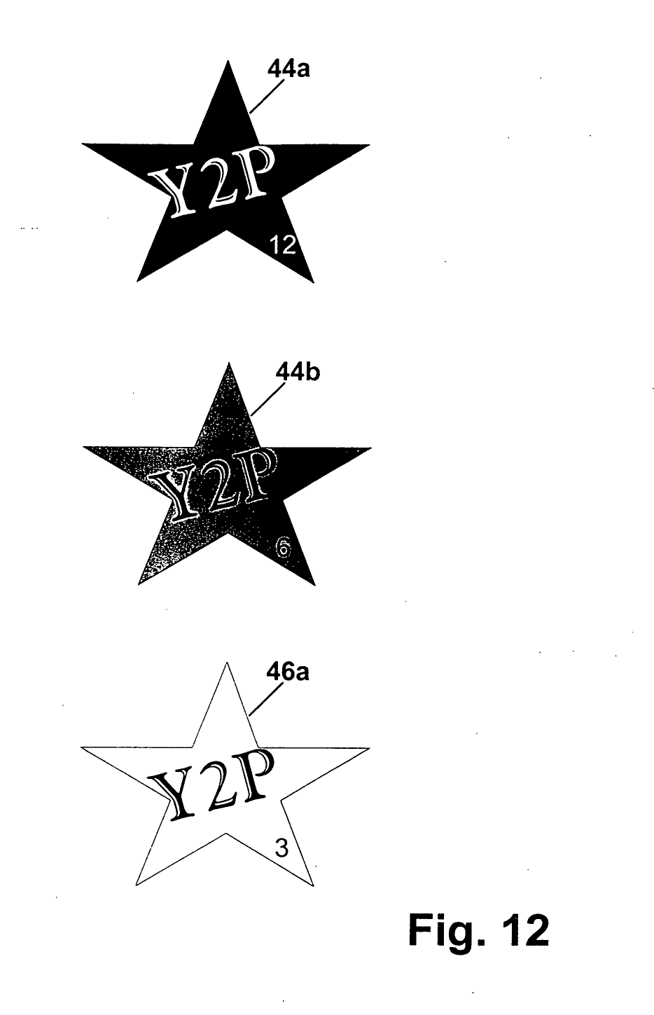

As mentioned above, deferred payment purchases can be made with the present invention in a variety of ways, including brick and mortar stores, catalog purchases, and online purchases, both at the deferred payment provider site and at merchant sites. In exemplary embodiments, the deferred payment system provider provides logos indicating acceptance of the deferred payment card. For example, merchants, manufacturers and service providers may display banners 42A, 42B and 42C on their storefronts, websites, television programs, catalogs, etc. Preferably, the logos for the various deferred payment options (e.g., twelve months, six months, three months) are different colors, for example, all logos relating to the twelve month deferred payment plan may be blue, those relating to the six month deferred payment plan may be red, and logos relating to the three month deferral plan may be yellow. Another example of a logo 44A, 44B, 44C is shown in FIG. 12. This logo is similar to logo 42A, 42B and 42C, and may be used on vendor websites, on products, etc.

The tiered option plan allows merchants, manufacturers and service providers flexibility in selecting various options for different products. For example, a jeweler may display a yellow emblem offering three months “same as cash” on a selected line of diamond necklaces. The same jeweler may also display the red emblems offering six months “same as cash” on all pendants in the store. They may also display the twelve month “same as cash” emblem on all liquidation and close-out items. This gives the retailer the option of which merchant discount fee they want to pay on which items that they offer for sale. For example, by offering the twelve month “same as cash” option, the merchant pays a higher merchant discount fee than for the three month and six month options, but still makes significantly more profit than placing the item for sale, for example, offering a 20-50% discount on the item.

Additional modifications and improvements of the present invention may also be apparent to those of ordinary skill in the art. Thus, the particular combination of parts described and illustrated herein is intended to represent only a certain embodiment of the present invention, and is not intended to serve as a limitation of alternative devices within the spirit and scope of the invention.

What is claimed is:

1. A method for making deferred payment purchases, the method comprising:
a. in response to a user request, determining a deferred credit limit for a deferred credit line for the user;
b. in response to a user request, performing at least one purchase transaction, wherein the at least one purchase transaction is made against the deferred credit line for the user.

2. The method of claim 1, wherein determining the deferred credit limit for the user comprises:
a. obtaining personal information from the user;
b. submitting the personal information to a financial institution; and
c. requesting a deferred payment credit line status from the financial institution.

3. The method of claim 2, wherein obtaining the personal information from the user is performed online.

4. The method of claim 2, wherein determining the deferred credit limit for the user further comprises informing the user of the deferred payment credit line status.

5. The method of claim 2, wherein the deferred payment credit line status comprises an approval indication or a denial indication.

6. The method of claim 2, wherein if the deferred payment credit line status is approval, the deferred payment credit line status further comprises the deferred payment credit limit for the deferred credit line for the user.

7. The method of claim 1, wherein the at least one of the at least one purchase transactions is an online purchase transaction.

8. The method of claim 7, wherein at least one of the at least one purchase transactions is performed exclusively at a deferred payment provider site.

9. The method of claim 7, wherein at least a portion of the purchase transaction is performed at a merchant site.

10. The method of claim 1, wherein at least one of the at least one purchase transactions is an offline purchase transaction.

11. The method of claim 1, wherein performing at least one purchase transaction comprises:
a. obtaining a payment for the purchase from a financial institution; and
b. making a payment for the purchase to a merchant.

12. The method of claim 1, further comprising processing a payment made by the user.

13. The method of claim 12, wherein processing the payment made by the user comprises:
a. receiving a payment from the user;
b. determining a payment amount to be paid to a financial institution; and
c. forwarding the determined payment amount to the financial institution.

14. The method of claim 1, wherein there are a plurality of deferred credit limits, each corresponding to a different deferral period.

15. A system for making deferred payment purchases, the system comprising:
a. a deferred payment server;
b. at least one customer;
c. at least one merchant; and
d. a network, wherein the deferred payment server, the at least one customer and the at least one merchant communicate over the network.

16. The system of claim 15, further comprising a financial institution, wherein a provider of the deferred payment server communicates with the financial institution.

17. The system of claim 15, wherein there is a single credit application and more than one merchant.

18. A computer readable medium having an executable component for making deferred payment purchases, wherein the executable component contains computer-executable instruction for:
a. in response to a user request, determining a deferred credit limit for a deferred credit line for the user;
b. in response to a user request, performing at least one purchase transaction, wherein the at least one purchase transaction is made against the deferred credit line for the user.

19. The computer readable medium of claim 18, wherein determining the deferred credit limit for the user comprises:
a. obtaining personal information from the user;
b. submitting the personal information to a financial institution; and
c. requesting a deferred payment credit line status from the financial institution.

20. The computer readable medium of claim 19, wherein obtaining the personal information from the user is performed online.

21. The computer readable medium of claim 18, wherein the at least one of the at least one purchase transactions is an online purchase transaction.

22. The computer readable medium of claim 21, wherein at least one of the at least one purchase transactions is performed exclusively at a deferred payment provider site.

23. The computer readable medium of claim 21, wherein at least a portion of the purchase transaction is performed at a merchant site.

24. The computer readable medium of claim 18, wherein there are a plurality of deferred credit limits, each corresponding to a different deferral period.
